(19) United States
(12) Patent Application Publication
(10) Pub. No.: US 2005/0004686 A1
(43) Pub. Date: Jan. 6, 2005

(54) Servo control apparatus control method

(76) Inventors: Atsushi Imazu, Fukuoka (JP); Hiroshi Nakamura, Fukuoka (JP); Hideki Honda, Fukuoka (JP); Jun Hagihara, Fukuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/491,983

(22) PCT Filed: Jun. 17, 2002
(86) PCT No.: PCT/JP02/06025

(30) Foreign Application Priority Data
Oct. 9, 2001 (JP) 2001-311790

(51) Int. Cl. G05B 13/02

(52) U.S. Cl. 700/44

(57) ABSTRACT

It is constructed so as to be able to follow without delay and flexibly cope with a change in a command of a host controller in the case of receiving a target command value at the present time from the host controller every certain period.

In a servo control apparatus 2 for causing an output of a controlled object 3 to follow target commands received from a host controller 1 every certain period, predictive target commands to the next M steps are generated every each period using a history of the target commands and command follow-up control is performed by predictive and preview control or feedback gain switching control using the predictive target commands.

### TECHNICAL FIELD

The present invention relates to a control method of a servo control apparatus for receiving target commands from a host controller every certain period and causing an output of a controlled object to follow the target commands, and particularly to a control method capable of speedily responding to the target commands.

### BACKGROUND ART

It is found that predictive and preview control using the next target command value is effective as a servo control method for causing an output of a controlled object to follow a target command and, for example, in JP-A-Hei7-28508, preview control is performed using the next target command incremental value, the past control input incremental value, an incremental output value of a controlled object, a deviation of the controlled object and predetermined preview control parameters.

However, in the case of performing predictive and preview control by receiving a target command value at the present time from a host controller every certain period, a motion is performed by considering that the target command value at the present time is a target command value of the next M steps, so that there was a problem that the motion delays by M samplings as shown in FIG. 6.

Therefore, a technique for solving the problem is developed and is disclosed in JP-A-Hei8-123537. According to that, it is characterized by using a command generator for generating target command values to the next M steps since the present time at sampling time of starting movement and generating only a target command value of the next M steps since the present time after the next sampling time, and as a result of this, the target command values to the next M steps since the present time can be used and M samplings of delay is solved as shown in FIG. 7.

However, in the control method disclosed in JP-A-8-123537, the command generator outputs the target command value of the next M steps with respect to the actual time, so that it is required that a motion be known. Accordingly, there was a problem of lack of flexibility with respect to a change in a command.

### DISCLOSURE OF THE INVENTION

Therefore, an object of the invention is to be constructed so as to be able to follow without M samplings of delay and flexibly cope with a change in a command of a host controller even in a configuration of receiving a target command value at the present time from the host controller every certain period.

A control method of a servo control apparatus of the invention is characterized in that in a servo control apparatus for causing an output of a controlled object to follow target commands received from a host controller every certain period, predictive target commands to the next M steps are generated every each period using a history of the target commands and command follow-up control is performed by predictive and preview control or feedback gain switching control using the predictive target commands.

Further, the invention is characterized in that in the case of generating predictive target commands to the next M steps, on the basis of a condition that derivative values of the target commands are constant to the next M steps, predictive target command derivative values are obtained and the predictive target command derivative values are summed to generate the predictive target commands to the next M steps.

Further, the invention is characterized in that in the case of generating predictive target commands to the next M steps, on the basis of a condition that second-order derivative values of the target commands are constant to the next M steps, predictive target command second-order derivative values are obtained and the predictive target command second-order derivative values are summed to calculate predictive target command derivative values and when the predictive target command derivative value exceeds a predetermined upper limit value, the predictive target command derivative value is changed to the upper limit value and when the predictive target command derivative value falls below a predetermined lower limit value, the predictive target command derivative value is changed to the lower limit value and when a sign of the predictive target command derivative value differs from a difference value of the target commands, the predictive target command derivative value is changed to zero and the predictive target command derivative values are summed to generate the predictive target commands.

### BRIEF DESCRIPTION OF THE DRAWINGS

FIG. 1 is a flowchart showing a processing procedure of a control method of the invention.

FIG. 2 is a flowchart showing a processing procedure of a second control method.

FIG. 3 is a flowchart showing a processing procedure of a third control method.

FIG. 4 is a block diagram of a servo control system to which the method of the invention is applied.

FIG. 5 is a diagram showing a state of response by the method of the invention.

FIG. 6 is a diagram showing a state of response by a method of a conventional example 1.

FIG. 7 is a diagram showing a state of response by a method of a conventional example 2.

FIG. 8 is an example of a predictive target command by the second method.

FIG. 9 is an example of a predictive target command by the third method.

### BEST MODE FOR CARRYING OUT THE INVENTION

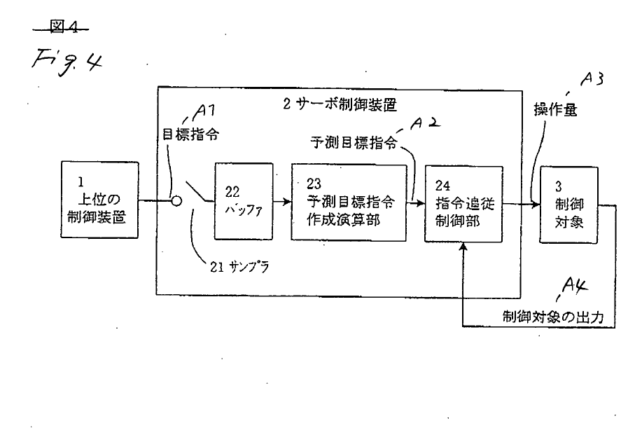

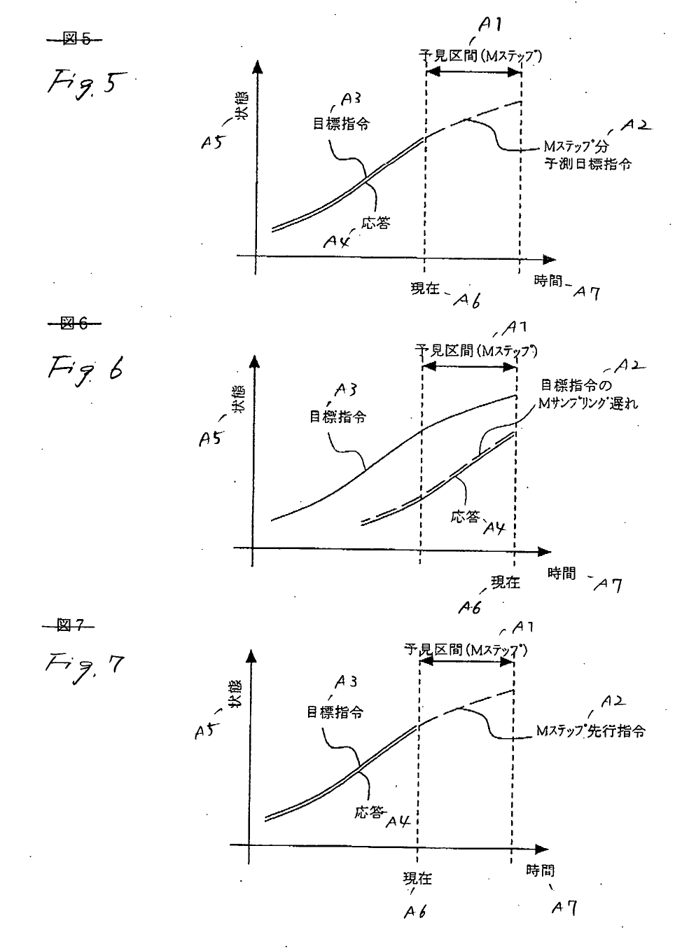

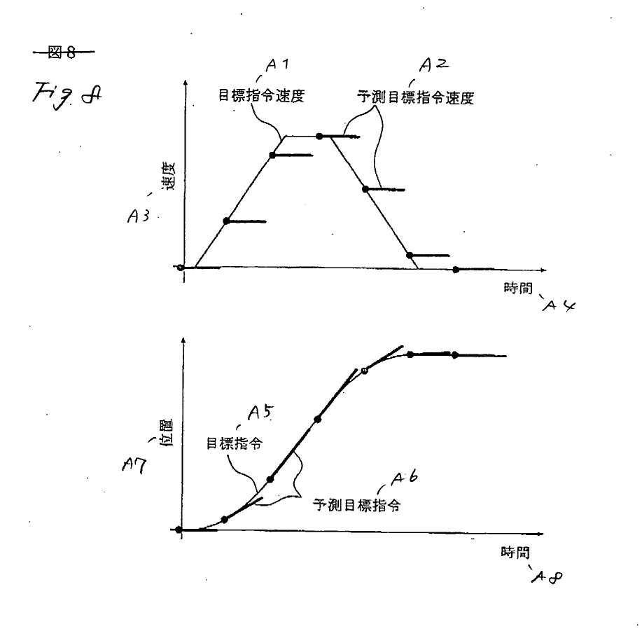

First, a servo control system for carrying out a method of the invention will be described using a block diagram of FIG. 4. In the diagram, numeral 1 is a host controller for outputting a target command, and numeral 2 is a servo control apparatus for performing control so that an output of a controlled object 3 follows the target command received from the host controller. The servo control apparatus 2 comprises a sampler 21, a buffer 22, a predictive target command generating part 23 and a command follow-up control part 24. When the command follow-up control part 24 and the controlled object 3 form a position control system, the command follow-up control part 24 comprises a driver such as a power amplifier and a position controller and an output of the controlled object 3 is information about a position outputted by a position detector provided inside the controlled object 3. When the command follow-up control part 24 and the controlled object 3 form a speed control system, the command follow-up control part 24 comprises a driver such as a power amplifier and a speed controller and an output of the controlled object 3 is information about a speed outputted by a speed detector provided inside the controlled object 3. The controlled object 3 comprises, for example, a motor, a ball screw, a table and the position detector or the speed detector, and a manipulated variable is a current supplied to the motor.

In such a configuration, when target commands are captured by the sampler 21 at certain periods, the target commands are buffered in the buffer 22. The target commands buffered are sequentially captured in the predictive target command generating calculation part 23 to calculate and output a predictive target command according to the method of the invention. When the predictive target command calculated is captured in the command follow-up control part 24, comparison with an output of the controlled object 3 is made and follow-up control is performed and a manipulated variable is outputted to the controlled object 3 to perform driving. Next, the method of the invention will be described in order along a processing procedure of a flowchart of FIG. 1.
(S11) The sampler 21 functions and target commands are acquired from the host controller 1 every sampling period and are buffered in the buffer 22.
(S12) Using a history of the target commands acquired, the predictive target command generating calculation part 23 generates M steps of predictive target commands.

(S13) Using the predictive target commands, the predictive target command generating calculation part 23 performs predictive and preview control to perform follow-up control. Instead of the predictive and preview control, follow-up control may be performed by deciding a state (in acceleration, deceleration, stop, etc.) of the next target command by the generated predictive target commands and performing feedback gain switching control for switching a feedback gain. Thereafter, the flowchart returns to (S11) and the procedure is repeated.

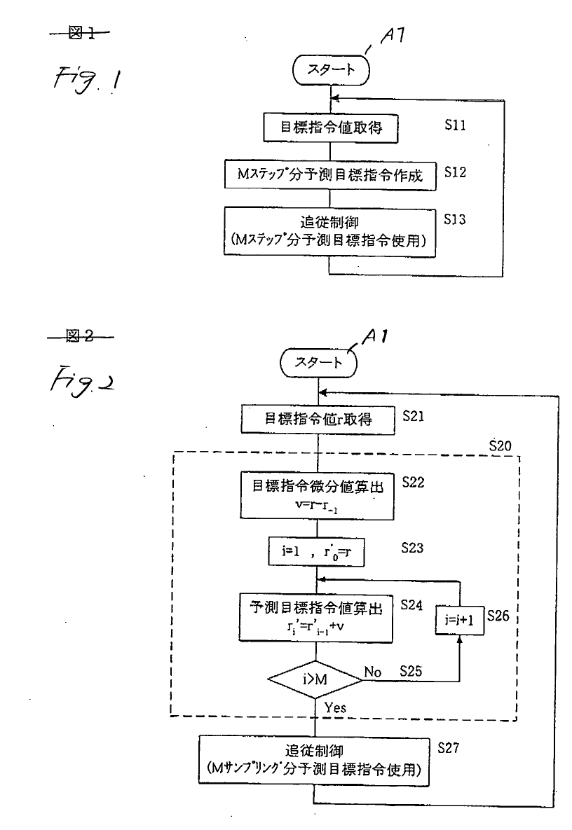

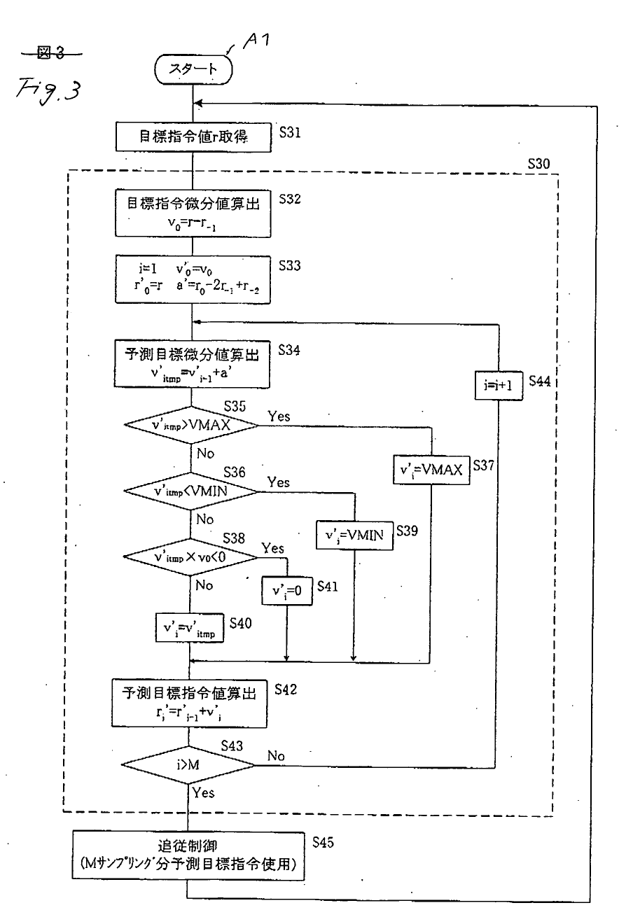

FIG. 2 is a flowchart showing a portion (S12) of the procedure of FIG. 1 in detail, and description will be made in order along this diagram.
(S21) The sampler 21 functions and target command values r are acquired from the host controller 1 every sampling period and are buffered in the buffer 22. Hereinafter, r0 is a target command value of this sample and r-i is a target command value of i samples past.
(S22) By a difference between the target command values r, a target command derivative value v is calculated using the following equation.
   v=r0−r-1
(S23) A counter i is initialized to 1 and an initial value r′0of a predictive target command value is set to the present target command value r.
(S24) A predictive target command value r′i is calculated using the following equation.
   r′i=r′i-1+v
(S25) It is decided whether or not i exceeds M, and if so, the flowchart proceeds to (S27) and if not, the flowchart proceeds to (S26).
(S26) The i is counted up by 1.
   By repeating by M steps in the procedure of (S24) to (S26), r′0 to r′m are calculated.
(S27) Using r′0 to r′m, command follow-up control is performed by predictive and preview control or feedback gain switching control, and the flowchart returns to (S21) and the procedure is repeated.

Incidentally, in the case of receiving a difference value of the target command from the host controller during the procedure described above, difference values of values received are set to v and the summation is set to r.

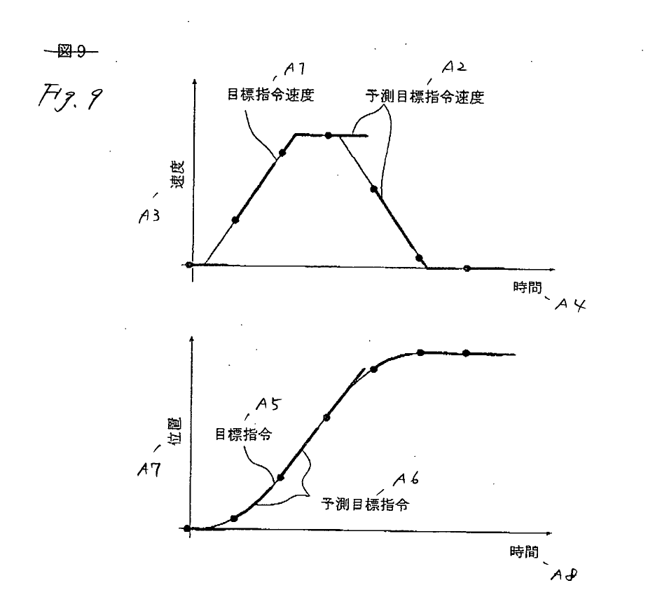

Next, a predictive target command calculated by the processing procedure mentioned above will be described. FIG. 8 is a predictive target command of the case of commanding a target position command in which a target command speed takes the form of a trapezoid speed. When a target command position and a target command speed change as shown by thin lines, with respect to several places shown by black circles, positions and speeds of predictive target command values predicted are shown by thick lines. As can be seen from this diagram, the predictive target command in which a target command is approximated by the algorithm described above can be obtained by simple and easy calculation.

FIG. 3 is a flowchart improving a portion (S20) of the procedure of FIG. 2, and description will be made in order along this diagram.
(S31) The sampler 21 functions and target commands r are acquired from the host controller 1 every sampling period and are buffered in the buffer 22. Hereinafter, r0 is a target command value of this sample and r-i is a target command value of i samples past.
(S32) By a difference between the target command values r, a target command derivative value v0 is calculated using the following equation.
   v0=r0−r-1
(S33) A counter i is initialized to 1 and an initial value r′0 of a predictive target command value is set to the present target command value r. Further, an initial value v′0 of a predictive target command derivative value is set to v0 and a predictive target command second-order derivative value a′ is calculated using the following equation.
   a=r0−2r-1+r-2
(S34) A temporary predictive target command derivative value v′itmp is calculated by the following equation.
   v′itmp=v′i-1+a′
(S35) It is decided whether or not v′itmp is larger than a predictive target command derivative value maximum value VMAX, and if so, the flowchart proceeds to (S37) and if not, the flowchart proceeds to (S36).
(S36) It is decided whether or not v′itmp is smaller than a predictive target command derivative value minimum value VMIN, and if so, the flowchart proceeds to (S39) and if not, the flowchart proceeds to (S38).
(S38) It is decided whether or not a product of v′itmp and v0 is smaller than 0, and if so, the flowchart proceeds to (S41) and if not, the flowchart proceeds to (S40).
(S37) It is set to v′i=VMAX and the flowchart proceeds to (S42)
(S39) It is set to v′i=VMIN and the flowchart proceeds to (S42)
(S41) It is set to v′i=0 and the flowchart proceeds to (S42).
(S40) It is set to v′i=v′itmp and the flowchart proceeds to (S42).
(S42) A predictive target command value r′i is calculated by the following equation.
   r′i=r′i-1+v′i
(S43) It is decided whether or not i exceeds M, and if so, the flowchart proceeds to (S45) and if not, the flowchart proceeds to (S44).
(S44) The i is counted up by 1 and the flowchart returns to (S34). By repeating the predictive target command value calculation step by M steps in the procedure of (S34) to (S44), r′0 to r′m are calculated.
(S45) Using r′0 to r′m, command follow-up control is performed by predictive and preview control or feedback gain switching control, and the flowchart returns to (S31) and the procedure is repeated. Incidentally, in the case of receiving a difference value of a position command from the host controller 1, difference values received may be set to v0 and the summation may be set to r.

Next, a predictive target command calculated by the processing procedure mentioned above will be described. FIG. 9 is a predictive target command of the case of commanding a target position command in which a target command speed takes the form of a trapezoid speed. When a target command position and a target command speed change as shown by thin lines, with respect to several places shown by black circles, positions and speeds of predictive target command values predicted are shown by thick lines. As can be seen from this diagram, target commands of constant acceleration and deceleration can be predicted accurately except immediately after starts of acceleration and deceleration.

### INDUSTRIAL APPLICABILITY

According to the invention, predictive target commands to the next M steps are generated by a history of target command values, so that even in the case of sequentially receiving the present command from a host controller every certain period, predictive and preview control or feedback gain switching control using the next target command values can be performed without delay with respect to the target command values of the host controller.

Further, products of sampling times and derivative values of target commands are summed to calculate predictive target command values to the next M steps, so that the predictive target command values can be obtained by a small amount of calculation and further, predictive and preview control or gain switching control using the predictive target command values can be performed.

Further, products of sampling times and second-order derivative values of target commands are summed to obtain derivative values of predictive target commands and products of sampling times and the derivative values of the predictive target commands are summed to obtain predictive target command values to the next M steps, so that target commands of constant acceleration and deceleration can be predicted accurately and further, there is an effect capable of performing predictive and preview control or gain switching control using the predictive target command values. Here, when derivatives of target command values move in a trapezoid by a condition that signs of derivative values of the predictive target command values remain unchanged and a condition that derivative values of the predictive target command values have upper limit and lower limit values, the predictive target command values for accurately predicting the time of a constant speed change and the time of a stop can be obtained.

1. A control method of a servo control apparatus for causing an output of a controlled object to follow target commands received from a host controller every certain period,
the control method comprising the steps of:
generating predictive target commands to the next M steps every each period using a history of the target commands, and
performing command follow-up control by predictive and preview control or feedback gain switching control with using the predictive target commands.

2. The control method of a servo control apparatus as claimed in claim 1, wherein
in a case of generating predictive target commands to the next M steps, on the basis of a condition that derivative values of the target commands are constant to the next M steps,
predictive target command derivative values are obtained, and the predictive target command derivative values are summed to generate the predictive target commands to the next M steps.

3. The control method of a servo control apparatus as claimed in claim 1, wherein
in a case of generating predictive target commands to the next M steps, on the basis of a condition that second-order derivative values of the target commands are constant to the next M steps, predictive target command second-order derivative values are obtained, and the predictive target command second-order derivative values are summed to calculate predictive target command derivative values,
when the predictive target command derivative value exceeds a predetermined upper limit value, the predictive target command derivative value is changed to the upper limit value,
when the predictive target command derivative value falls below a predetermined lower limit value, the predictive target command derivative value is changed to the lower limit value, and
when a sign of the predictive target command derivative value differs from a difference value of the target commands, the predictive target command derivative value is changed to zero, and the predictive target command derivative values are summed to generate the predictive target commands.
